(19) United States
(12) Patent Application Publication
(10) Pub. No.: US 2019/0190114 A1
(43) Pub. Date: Jun. 20, 2019

(54) POLARIZER ASSEMBLY

(71) Applicant: Parker-Hannifin Corporation, Cleveland, OH (US)

(72) Inventor: Peter Z. TOROK, Brockport, NY (US)

(21) Appl. No.: 16/326,193

(22) PCT Filed: Sep. 6, 2017
(86) PCT No.: PCT/US2017/050173

§ 371 Date: Feb. 16, 2019

Related U.S. Application Data
(60) Provisional application No. 62/383,803, filed on Sep. 6, 2016.

(51) Int. Cl. H01P 11/00; H01P 1/04; H01P 1/17

(52) U.S. Cl. CPC H01P 11/002; H01P 1/17; H01P 1/042

(57) ABSTRACT

A polarizer assembly including first and second components. The first component includes a first channel portion extending along a first component axis and having a plurality of first locking projections and/or first openings on opposite sides of the first channel portion. The second component includes a second channel portion extending along a second component axis and having a plurality of second locking projections and/or second openings on opposite sides of the second channel portion. The second component is rotatable relative to the first component about a common rotation axis between a pre-assembled position in which the second component axis is angularly offset from the first component axis, and an assembled position in which the second locking projections and/or second openings mate with the first locking projections and/or first openings and the first and second channel portions form a channel that functions to polarize waveforms.

### RELATED APPLICATIONS

This application claims the benefit of U.S. Provisional Application No. 62/383,803 filed Sep. 6, 2016, which is hereby incorporated herein by reference.

### FIELD OF INVENTION

This application relates generally to satellite communications antenna systems and devices, and more particularly to polarizer assemblies for such systems and devices.

### BACKGROUND

Conventional ground based satellite communication antenna systems may include for example an antenna feed horn connected to a transceiver. More specifically, transmit and receive ports of the transceiver are connected to an orthomode transducer (OMT) waveguide device, which includes one or more waveguides. The waveguides of the OMT waveguide device, in turn, are connected to one end of a polarizer assembly. An opposite end of the polarizer assembly is connected to the feed horn antenna.

The typical polarizer assembly may include a pair of one part geometry components or be made up of parts having different geometries. Whether the geometric configuration is single or multi part, a gap free continuous seal bead between the first and second components is required for proper signal processing performance by the channel.

For some polarizer assemblies, there remain various shortcomings, drawbacks, and disadvantages relative to certain applications. For example, some polarizer assemblies utilize a snap fit assembly wherein tabs or projections on one component snap into slots or grooves in a second component. The problems with such an approach include higher manufacturing costs associated with the two components requiring two unique geometries and insufficient seam line integrity in the channel between the components. Other polarizer assemblies have used thread forming screws to assemble the two components. While this method has proven capable, it is not as cost effective as current die casting versions. Thread forming screws provide good retention capability, however hardware and assembly labor requirements limit cost effectiveness. Another variation for assembly is to use heat staking by converting screw bosses to posts that are staked into ‘rivet heads.’ The heat staking method provides moderate retention capability and is more cost effective than thread forming screws, however the capital equipment cost is very high. There is also some risk due to the heat required to stake parts together; that is, the heat may cause the components to distort. The overall cost is better than die casting, although long cycle times are required for each assembly.

Accordingly, there remains a need for further contributions in this area of technology.

### SUMMARY OF INVENTION

The present invention is directed to a polarizer assembly in which projections and openings of a first component are mated with projections and openings of a second component upon relative rotation between the components to an assembled position. The resulting assembled component provides a tight seal bead along edges of channel portions of the first and second components. According to one aspect of the invention, the polarizer assembly includes a first component including a first channel portion extending along a first component axis and having a plurality of first locking projections and/or first openings on opposite sides of the first channel portion; and a second component including a second channel portion extending along a second component axis and having a plurality of second locking projections and/or second openings on opposite sides of the second channel portion. The second component is rotatable relative to the first component about a common rotation axis between a pre-assembled position in which the second component axis is angularly offset from the first component axis, and an assembled position in which the second locking projections and/or second openings mate with the first locking projections and/or first openings and the first and second channel portions form a channel that functions to polarize waveforms.

Embodiments of the invention may include one or more of the following additional features separately or in combination.

The first and second components may have the same geometry.

In the assembled position, the first and second components may be configured to attach to a waveguide at one end and a feed horn at an opposite end, and the common rotation axis may be positioned closer to the waveguide end.

The channel may be square at one end and circular at an opposite end.

The plurality of first locking projections and/or first openings may be formed in first flanges on opposite sides of the first channel portion, and the plurality of second locking projections and/or second openings may be formed in second flanges on opposite sides of the second channel portion.

In the assembled position, the plurality of second locking projections and/or second openings may mate with the plurality of first locking projections and/or first openings to clamp respective edges of the first and second channel portions into an interference fit.

The plurality of first locking projections and/or first openings may include a plurality of first tabs and/or slots, and the plurality of second locking projections and/or second openings may include a plurality of second tabs and/or slots.

The plurality of first locking projections and/or first openings may be progressively further radially spaced from the common rotation axis, and the plurality of second locking projections and/or second openings may be progressively further radially spaced from the common rotation axis.

The first component may include a post that is configured to slide axially into an opening in the second component in the direction of the common rotation axis to align the first and second components along the common rotation axis.

The post may have an arc shape and the opening may have an arc shape, and the angular span of the arc shape post may be less than the angular span of the arc shape opening.

The arc shape post may be configured to slidably fit into the arc shape opening to angularly offset the second component axis relative to the first component axis and position the first and second components into the pre-assembled position.

An inner radius of the post can be configured to slide against an outer radius of a wall of the opening to guide rotational movement of the second component relative to the first component between the pre-assembled position and the assembled position.

The plurality of first locking projections and/or first openings may include a wedge shape locking tab, and the plurality of second locking projections and/or second openings may include a wedge shape slot. The wedge shape locking tab may be configured to engage walls of the wedge shape slot as the second component is rotated into the assembled position.

The wedge shape locking tab may be formed axially above an undercut in the post that extends circumferentially inward from an edge of an angular span of the post. The wedge shape slot may be formed by a groove that extends circumferentially outward from an edge of an angular span of the opening.

The plurality of first locking projections and/or first openings may include locking tabs progressively further radially spaced from the common rotation axis, and the plurality of second locking projections and/or second openings may include slots progressively further radially spaced from the common rotation axis.

The progressively further radially spaced slots may open up to an edge of a second flange of the second component and be configured to circumferentially slidably receive the respective progressively further radially spaced locking tabs of the first component as the second component is rotated from the pre-assembled position to the assembled position.

The locking tabs may include posts projecting from a first flange face of the first component axially in the direction of the common rotation axis, and at least one projection extending laterally from the post, the projection and first flange face defining therebetween a circumferentially extending guideway within which an edge of the corresponding mating slot moves as the second component is rotated to the assembled position.

The at least one laterally extending projection may include a pair of laterally extending projections that project radially toward and radially away from the post, the projections and first flange face defining therebetween circumferentially extending guideways within which opposite edges of the corresponding mating slot move as the second component is rotated to the assembled position.

The at least one laterally extending projection of the locking tab furthest from the common rotation axis may project radially from the post.

The first component may include a spring actuated tab and the second component may include a mounting hole that receives the spring actuated tab in the assembled position to rotationally lock the second component to the first component.

The spring actuated tab may be configured to flex away from the second component as the second component is rotated from the pre-assembled position toward the assembled position, and to flex back toward the second component in the assembled position.

The spring actuated tab may include a tab connected to a flexible cantilever arm that in turn is connected to a portion of a flange of the first component, with the flexible cantilever arm being configured to flex as the second component is rotated from the pre-assembled position toward the assembled position.

The flexible cantilever arm may include a ramp that the second component slides against to gradually flex the cantilever arm as the second component is rotated from the pre-assembled position toward the assembled position.

The flexible cantilever arm may be connected to an outer portion of the first flange and project circumferentially toward the first channel portion.

According to another aspect of the invention, a method of assembling a polarizer assembly includes aligning a first component and a second component axially along a common rotation axis. The first component includes a first channel portion extending along a first component axis and having a plurality of first locking projections and/or first openings on opposite sides of the first channel portion. The second component includes a second channel portion extending along a second component axis and having a plurality of second locking projections and/or second openings on opposite sides of the second channel portion. The method includes arranging the first component axis of the first component to be angularly offset about the common rotation axis relative to the second component axis of the second component. The method further includes rotating the second component relative to the first component about the common rotation axis from the pre-assembled position to an assembled position in which the first locking projections and/or first openings mate with the second locking projections and/or second openings and the first and second channel portions form a channel that functions to polarize waveforms.

The axially aligning the first and second components along the common rotation axis may include sliding a post of the first component axially into an opening in the second component in the direction of the common rotation axis.

As the second component is rotated relative to the first component from the pre-assembled position to the assembled position, edges of the second channel portion may be gradually clamped into an interference fit with edges of the first channel portion.

The method may further include flexing a spring actuated tab away from the second component as the second component is rotated from the pre-assembled position toward the assembled position, and flexing the spring actuated tab back toward the second component in the assembled position to rotationally lock the second component to the first component.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a block diagram of a satellite communications antenna system in accordance with the invention.

FIG. 2 is a perspective view of a polarizer assembly of the FIG. 1 antenna system in accordance with the invention, showing first and second components of the polarizer assembly in an assembled state.

FIG. 2A is a cross sectional view of the FIG. 2 polarizer assembly at a waveguide connection end thereof as viewed from the plane 2A-2A in FIG. 2.

FIG. 2B is a cross sectional view of the FIG. 2 polarizer assembly at a central portion thereof as viewed from the plane 2B-2B in FIG. 2.

FIG. 2C is a cross sectional view of the FIG. 2 polarizer assembly at a feed horn connection end thereof as viewed from the plane 2C-2C in FIG. 2.

FIG. 3 is an exploded perspective view of the FIG. 2 polarizer assembly.

FIG. 4 is a top plan view of the polarizer assembly in a pre-assembled state, showing first and second components stacked over each other aligned over a center of rotation axis.

FIG. 5 is an enlarged perspective view of a portion of the polarizer assembly in a pre-assembled state, showing a locking tab and slot of a locking mechanism in an unengaged state.

FIG. 6 is an enlarged perspective view of a portion of the polarizer assembly in an assembled state, showing the locking tab and slot of the locking mechanism in an engaged state.

FIG. 7 is an enlarged perspective view of a portion of the polarizer assembly in a pre-assembled state, showing locking tabs of one component and mating slots of an opposite component, and showing a snap locking mechanism of the components in an unengaged state.

FIG. 8 is an enlarged perspective view of a portion of the polarizer assembly in an assembled state, showing a locking tab of one component mated with a slot of an opposite component.

FIG. 9 is an enlarged perspective view of a portion of the polarizer assembly in an assembled state, showing a locking tab of one component mated with a slot of an opposite component.

FIG. 10 is an enlarged perspective view of a portion of a component of the polarizer assembly, showing a tab of the snap locking mechanism.

FIG. 11 is an enlarged perspective view of a portion of a component of the polarizer assembly, showing a mounting hole of the snap locking mechanism.

FIG. 12 is an enlarged perspective view of a portion of the polarizer assembly in a pre-assembled state, showing the tab of one component starting to engage an edge of an opposite component as the components are assembled together.

FIG. 13 is a cross-section view of a portion of the polarizer assembly in an assembled state, showing a tab of one component engaged with a mounting hole of an opposite component, and showing a locking tab of one component mated with a slot of an opposite component.

FIG. 14A is a cross sectional view of a first component of the polarizer assembly at a waveguide connection end thereof as viewed from the plane 14A-14A in FIG. 3.

FIG. 14B is a cross sectional view of the first component of the polarizer assembly at a central portion thereof as viewed from the plane 14B-14B in FIG. 3.

FIG. 15 is a flowchart of a method of assembling a polarizer assembly in accordance with the invention.

### DETAILED DESCRIPTION

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments, and any further applications of the principles of the invention as described herein, are contemplated as would normally occur to one skilled in the art to which the invention relates.

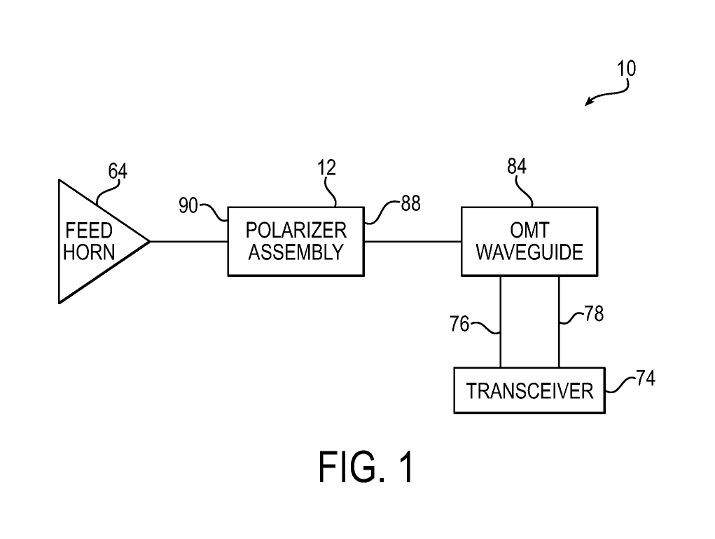

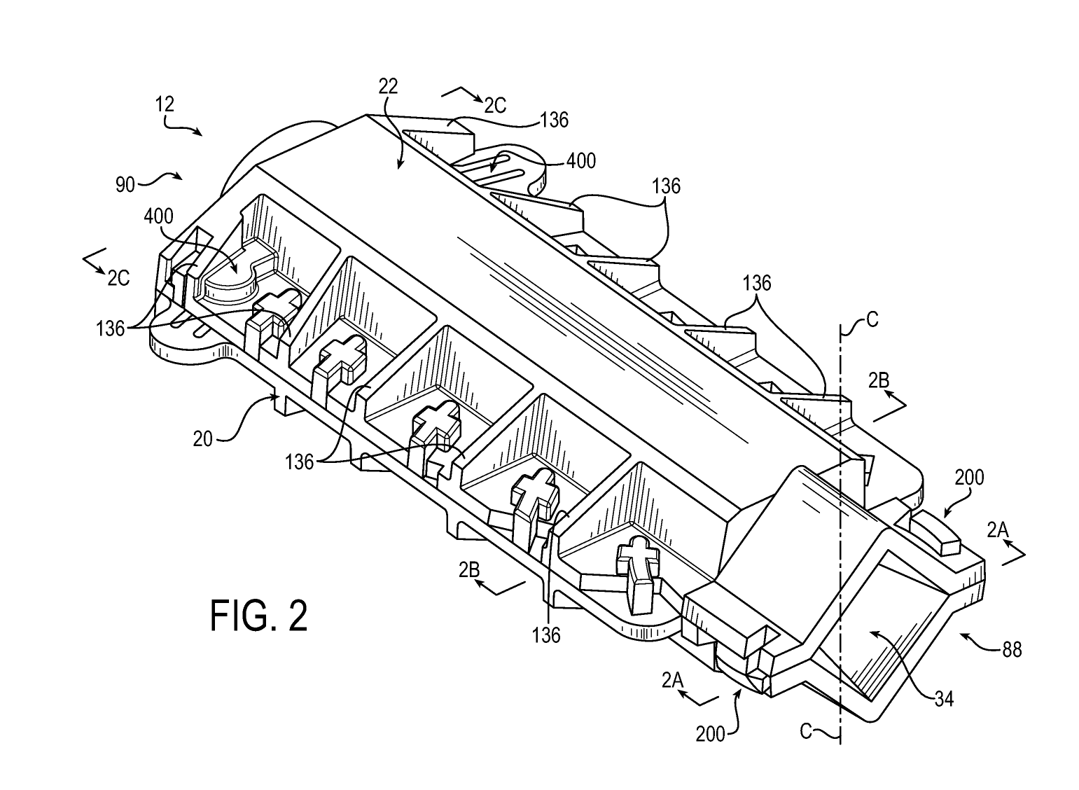

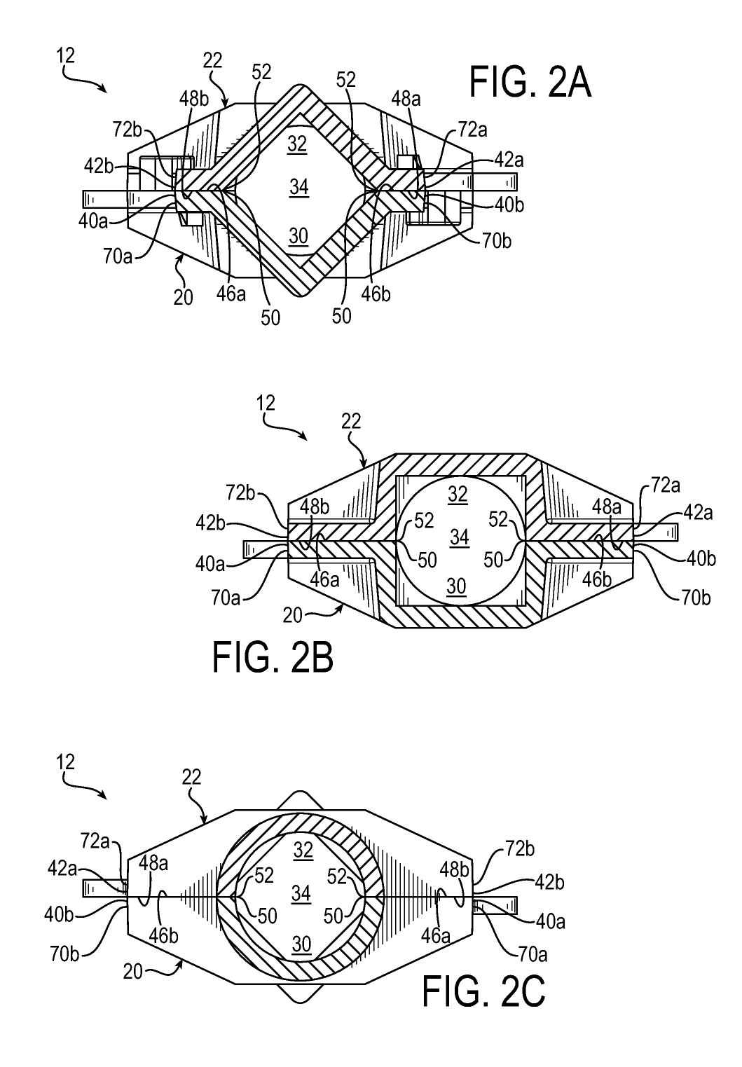

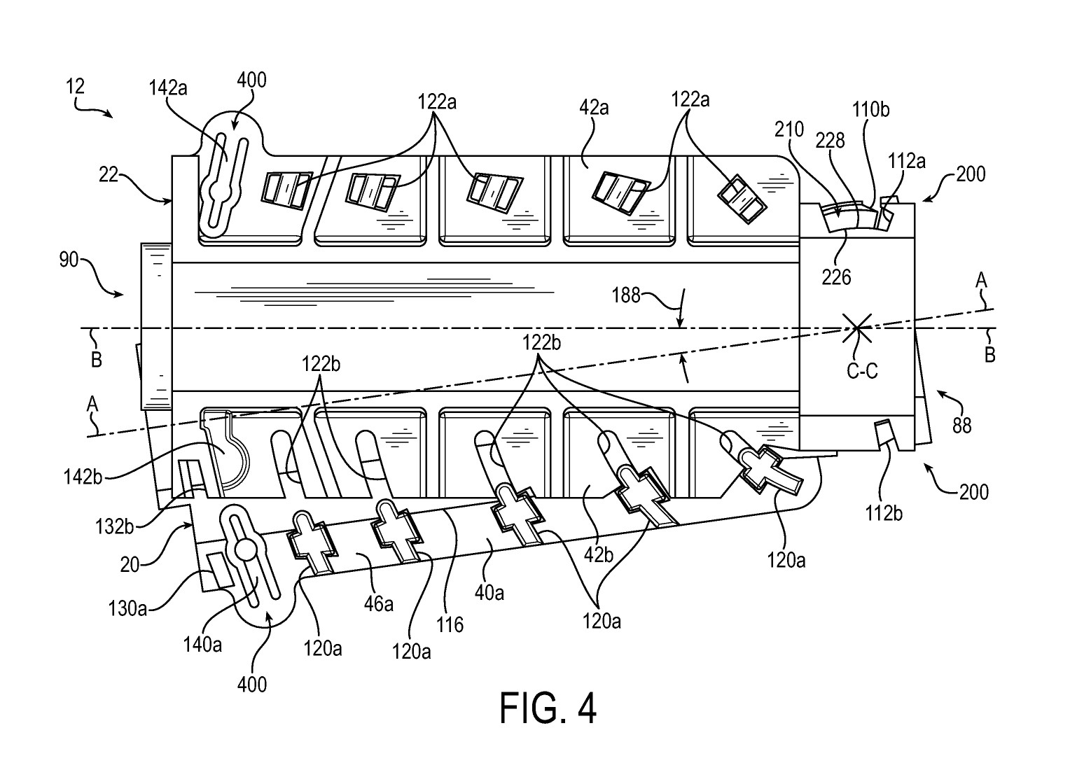

FIGS. 1-4 show a satellite communications antenna system 10 and a polarizer assembly 12 thereof in accordance with the invention. The satellite communications antenna system 10 is merely an example application of the polarizer assembly 12, and the polarizer assembly 12 can be used in any electronics application for which microwave radio frequency (RF) signal shaping and filtering is desired. As shown in FIGS. 2-4, the polarizer assembly 12 may include first and second “clamshell” components 20, 22. The first component 20 may include a first channel portion 30 extending along a first component axis A-A and have a plurality of first locking projections and/or first openings 100a, 100b on opposite sides of the first channel portion 30. Similarly, the second component 22 may include a second channel portion 32 extending along a second component axis B-B and have a plurality of second locking projections and/or second openings 102a, 102b on opposite sides of the second channel portion 32. As will be described in greater detail below, the second component 22 may be rotatable relative to the first component 20 about a common rotation axis C-C between a pre-assembled position shown in FIG. 4 in which the second component axis B-B is angularly offset from the first component axis A-A, and an assembled position shown in FIG. 2 in which the second locking projections and/or second openings 102a, 102b mate with the first locking projections and/or first openings 100a, 100b, and the first and second channel portions 30, 32 form a channel 34. The channel 34 functions to polarize waveforms, for example, from a waveguide to a feed horn 64 of the satellite communications antenna system 10. As shown in FIGS. 2A-2C, the first and second projections and openings 100a, 100b, 102a, 102b form a tight seal bead along edges 50, 52 of the respective first and second channel portions 30, 32, and clamp in face to face relation the flange faces 46a, 46b, 48a, 48b from the contact regions 50, 52 to the outer edges 70a, 70b, 72a, 72b of the first and second components 20, 22, and, owing to this clamping effect, the first and second projections and openings 100a, 100b, 102a, 102b maintain seam line integrity once the first and second components 20, 22 are in the assembled position.

Referring to FIG. 1, the satellite communications antenna system 10 may include an antenna feed horn 64 connected to a transceiver 74. Transmit and receive ports 76, 78 of the transceiver 74 may be connected to an orthomode transducer (OMT) waveguide device 84. The OMT waveguide device 84 may include one or more waveguides. The waveguides of the OMT waveguide device 84, in turn, may be connected to one end 88, also referred to herein as a waveguide connection end 88, of the polarizer assembly 12. An opposite end 90 of the polarizer assembly 12, also referred to herein as a feed horn connection end 90, may be connected to the feed horn antenna 64. As shown in FIGS. 2A and 2C, respectively, the channel 34 of the polarizer assembly 12 is square at the waveguide end 88 and circular at the opposite feed horn end 90, while the central portion is also square but angularly offset by 45 degrees relative to the waveguide end 88. The polarizer assembly 12 may be configured to align the input of many divergent wave orientations within target frequencies into polarized horizontal and/or vertical waveforms. Thus, for example, the channel 34, or central passageway, of the polarizer assembly 12 may be configured to convert linearly polarized signals to circular polarized signals and/or vice versa. Of course, other configurations and types of polarizer assemblies are also contemplated. Moreover, it will be apparent to those skilled in the art that the present invention relates to a bead seal for any two piece or other multi-piece radio frequency (RF) filtering device and, while herein the RF filtering device is described in terms of a polarizer assembly 12, it will be understood that the polarizer assembly 12 is only one application of the invention and is in no way limiting to the invention. The invention can be used for any multi-piece construction of a polarizer, waveguide, or any other radio frequency filtering assembly, including clamshell and non-clamshell configurations.

The polarizer assembly 12 may be constructed of metal, such as zinc die cast material, or metal coated thermoplastic injection molded material. In one embodiment, the components 20, 22 are made of a PC-ABS thermoplastic (polycarbonate/acrylonitrile butadiene styrene), cleaned, and then etched with a copper layer, for example, a layer of about 4 microns. The metal layer can be etched on the entire thermoplastic surface of the components 20, 22 or merely on the functional surfaces such as the inside surfaces of the channel portions 30, 32 and at the seal bead and flange faces 46a, 46b, 48a, 48b of respective flanges 40a, 40b, 42a, 42b of the first and second components 20, 22. Of course, other types of materials and manufacturing methods are also contemplated.

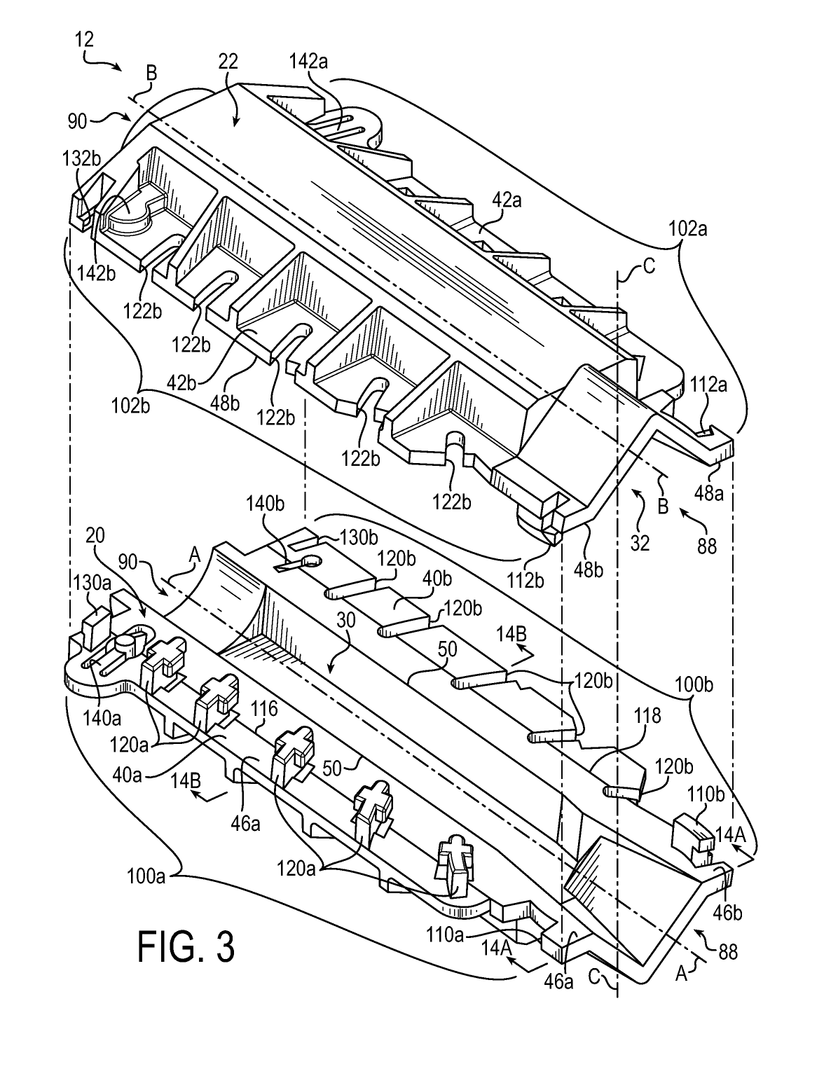

Referring now to FIGS. 2-4, the illustrative polarizer assembly 12 may be made up of a pair of one part geometry components; that is, the first and second components 20, 22 may have identical geometries. One part geometries can reduce the cost of manufacture as compared to polarizer assemblies that consist of mated components having different geometries. The projections and openings 100a of the left flange 40a and projections and openings 100b of the right flange 40b of the first component 20 may be configured to slidably engage with the respective projections and openings 102b of the right flange 42b and projections and openings 102a of the left flange 42a of the second component 22. The projections may take the form of any one or more of tabs, plugs, posts, nubs, protrusions, etc. and the openings may take the form of any one or more of holes, slots, cavities, recesses, etc. For example, the plurality of first locking projections and/or first openings 100a, 100b may include a plurality of first tabs and/or slots, and the plurality of second locking projections and/or second openings 102a, 102b may include a plurality of second tabs and/or slots, where the second tabs mate with the first slots and the second slots mate with the first tabs. In the embodiment of FIG. 3, the left flange 40a of the first component 20 has an opening 110a, five T-shape tabs 120a, an L-shape tab 130a, and a spring actuated tab 140a, while the right flange 42b of the opposite mating second component 22 has a tab 112b that mates with the corresponding opening 110a, five slots 122b that mate with the corresponding T-shape tabs 120a, a slot 132b that mates with the corresponding L-shape tab 130a, and a mounting hole 142b that mates with the spring actuated tab 140a. Similarly, the left flange 42a of the second component 22 has an opening 112a, five T-shape tabs 122a, an L-shape tab 132a, and a spring actuated tab 142a, while the right flange 40b of the opposite mating first component 20 has a tab 110b that mates with the corresponding opening 112a, five slots 120b that mate with the corresponding T-shape tabs 122a, a slot 130b that mates with the corresponding L-shape tab 132a, and a mounting hole 140b that mates with the spring actuated tab 142a.

The first locking projections and/or first openings 100a, 100b of the first component 20 and the second locking projections and/or second openings 102a, 102b of the second component 22 may be configured to sweep, or rotate, about the same center of rotation axis C-C, also referred to herein as a common rotation axis C-C. The first locking projections and/or first openings 100a, 100b may be progressively further radially spaced from the common rotation axis C-C, and the second locking projections and/or second openings 102a, 102b may be progressively further radially spaced from the common rotation axis C-C. The male features of one component and the female features of an opposing component may be on radial positions (relative to the common rotation axis C-C) that are aligned with each other. Thus, as shown in FIGS. 3 and 4, the tabs 110b, 112b may be the same radial distance from the axis C-C as the openings 110a, 112a; the tabs 120a, 122a may be the same radial distance from the axis C-C as the slots 120b, 122b; the tabs 130a, 132a may be the same radial distance from the axis C-C as the slots 130b, 132b; and the tabs 140a, 142a may be the same radial distance from the axis C-C as the mounting holes 142a, 142b. When the second component 22 is flipped in a clamshell manner 180 degrees about its second component axis B-B as shown in FIGS. 3 and 4, and then set on top of the first component 20 and aligned with the first component 20 along the common rotation axis C-C, and the second component axis B-B is arranged angularly offset by an angle 188 from the first component axis A-A as shown in FIG. 4, the components 20, 22 are in a pre-assembled position in which the projections and openings 102b, 102a of one component 22 are ready to be mated to the respective openings and projections 100a, 100b of the opposing component 20. In the pre-assembled position of the illustrative embodiment, the angular offset 188 between the first component axis A-A and the second component axis B-B is about 8.0 degrees. The spring actuated tabs 140a, 142a and mating mounting holes 140b, 142b of the first and second projections and openings 100a, 100b, 102a, 102b may be at opposite axial ends of the components 20, 22 as shown in FIGS. 3 and 4. As will be described in greater detail below, the spring actuated tabs 140a, 142a and mounting holes 140b, 142b, when mated, may be configured to aid in rotationally locking the components 20, 22 and/or properly axially and transversely aligning the components 20, 22. As shown in FIG. 2, the flanges 40a, 40b, 42a, 42b may also be provided with axially spaced gussets or ribs 136 between the projection and opening locations to strengthen the components 20, 22 and prevent over flexing of the flanges 40a, 40b, 42a, 42b or buckling of the flanges 40a, 40b, 42a, 42b around the projections and openings during assembly.

In the illustrative embodiment, the first and second components 20, 22 are one part geometry components, and thus the projections and openings 100a on the left flange 40a of the first component 20 are identical to the projections and openings 102a of the left flange 42a of the second component 22, and the projections and openings 100b on the right flange 40b of the first component 20 are identical to the projections and openings 102b of the right flange 42b of the second component 22. As will be appreciated by those skilled in the art, the first and second components 20, 22 need not be limited to one part geometries and the means for clamping and/or fastening the first and second components 20, 22 need not be limited to the projections and openings 100a, 100b, 102a, 102b or have the arrangement of the projections and openings 100a, 100b, 102a, 102b shown in the figures. The first and second components 20, 22 may have different geometries. For example, the left and right flanges of the first component 20 may be fitted with all projections while the left and right flanges of the second component 22 are configured with corresponding mating openings. In another form, assembling may alternately or additionally be by fastening, for example thread forming screws that engage pilot holes in the flanges 40a, 40b, 42a, 42b, or machine bolts that pass through holes in the flanges 40a, 40b, 42a, 42b and are secured by nuts to form bolted joints along the flanges 40a, 40b, 42a, 42b. The left and right flanges of the first component 20 may be fitted with bosses and pilot holes while the left and right flanges of the second component 22 are configured with through holes. In yet another form, heat staking may be used, whereby for example plastic or metal posts on the first flange are inserted into corresponding boss holes in the opposing flange, followed by swaging the material at the top of the posts to form a “rivet” head that clamps down on the bosses to secure the flanges together. One or more external clamps, for example binder clips, can also or alternately be used to secure the flanges together. The first and second components 20, 22 may also or alternatively be clamped together by means of projections in one component locking and mating with openings in the opposite component, where the projections may be in the form of one or more of tabs, plugs, posts, nubs, protrusions, among others, and the openings may take the form of any one or more of holes, slots, cavities, recesses, among others. The first component may include thread forming screws that engage “unthreaded bosses” in the opposing second component. The first component may include standard screws passed through openings in the first component, with nuts on the opposite half of the screw head half at the second component. Standard rivets that are “headed” may also or alternatively be used to retain clamped closure of the first and second components when they are assembled. Snap fit tabs may also or alternatively be used, whereby for example tabs in the first component flex during assembly of the first component to the second component and, once in an assembled position, snap back into an opening in the second component to lock the first and second components in the assembled position. In one form, the snap fit tabs may be “snap barbs” in the first component and “snap barb receptacles” in the opposite facing second component. The assembling could also use any combination of the foregoing, such as by clamping 110a, 110b, 112a, 112b and rotational locking 140a, 140b, 142a, 142b at the axially opposite ends of the flanges 40a, 40b, 42a, 42b, and fasteners at the axially central portion of the flanges 40a, 40b, 42a, 42b. In another alternative combination, the fastening and/or clamping could incorporate clamping at the axially opposite ends of the flanges, and thread forming screws at the axially central portion of the flanges. Of course, other configurations and fastening methods may also or alternately be employed, as will be appreciated.

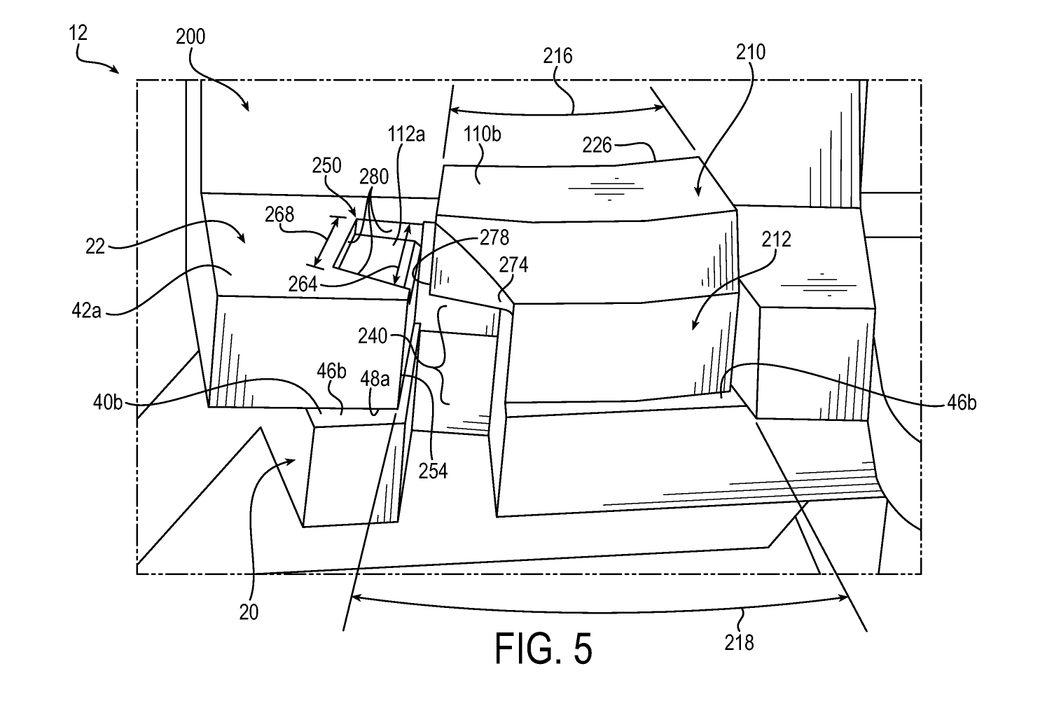

Reference is now made to FIGS. 5-13, which show greater detail of the projections and openings 100a, 100b, 102a, 102b of the first and second components 20, 22 and the engagements that take place in the mating of the projections and openings 100a, 100b, 102a, 102b as the components 20, 22 are assembled from the pre-assembled position of FIG. 4 to the assembled position of FIG. 2.

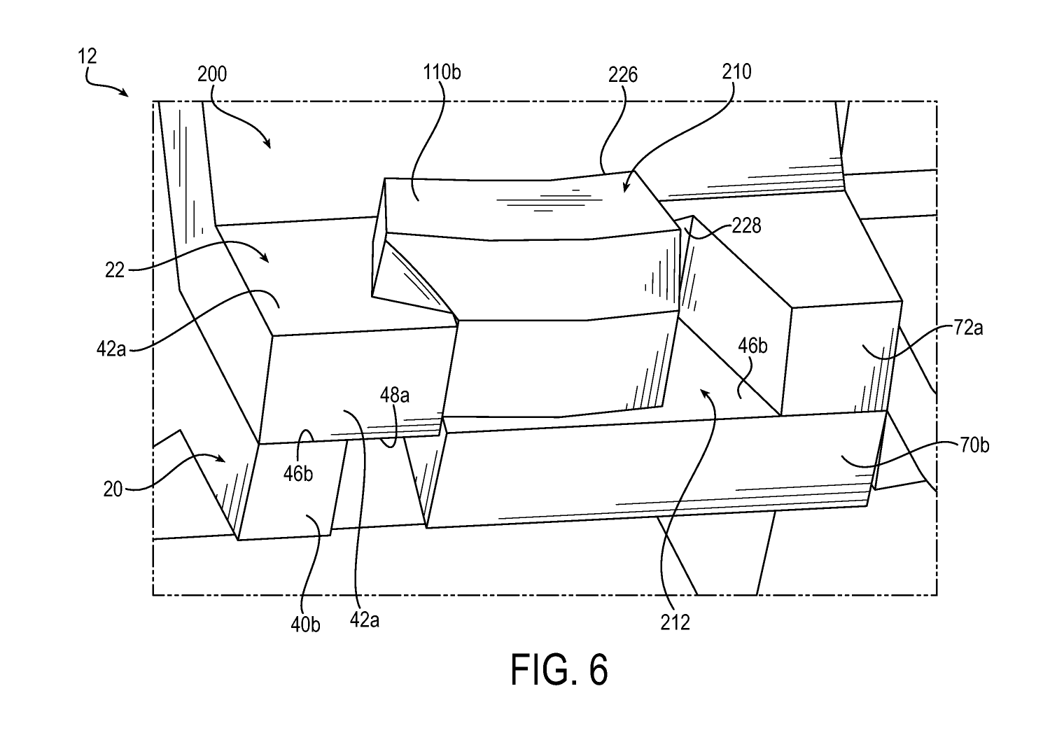

FIGS. 5 and 6 show a locking mechanism 200 that axially and rotationally locks the second component 22 to the first component 20 of the polarizer assembly 12. The locking mechanism 200 includes the locking tab 110b of the first component 20 and the mating slot 112a of the second component 22. FIG. 5 shows the locking mechanism 200 in a pre-assembled position in which the locking tab 110b and mating slot 112a are not engaged, while FIGS. 2 and 6 show the locking mechanism 200 (two locking mechanisms 200 in FIG. 2) in an assembled position in which the locking tab 110b and mating slot 112a are engaged.

The locking mechanism 200 may include a post 210 that projects upward from the flange face 46b of the flange 40b of the first component 20 and an opening 212 that extends axially through the flange 42a of the second component 22. The post 210 may be configured to slide axially into the opening 212 in the direction of the common rotation axis C-C to align the first and second components 20, 22 along the common rotation axis C-C. The post 210 and the opening 212 may each have an arc shape. The angular span 216 of the arc shape post 210 may be slightly less than the angular span 218 of the arc shape opening 212. As shown in FIG. 4, the arc shape post 210 is configured to axially slidably fit into the arc shape opening 212 to angularly offset the second component axis B-B relative to the first component axis A-A by the angle 188 to thereby position the first and second components 20, 22 into the pre-assembled position. In addition, an inner radius 226 of the post 210 may be configured to slide against an outer radius 228 of a wall of the opening 212 to guide rotational movement of the second component 22 relative to the first component 20 between the pre-assembled position and the assembled position. In the illustrative embodiment, the angular offset 188 is about 8.0 degrees, although it will be appreciated that other angles may be suitable depending on for example the flange sizes of the components 20, 22, and the appropriate proximity of the locking mechanisms 200 to the edges 50, 52 of the first and second channel portions 30, 32 to effect a proper bead seal.

As noted above, the plurality of first locking projections and/or first openings 100a, 100b may include the locking tab 110b, and the plurality of second locking projections and/or second openings 102a, 102b may include the mating slot 112a. In the FIG. 5 locking mechanism 200, the locking tab 110b has a wedge shape that corresponds to a wedge shape of the mating slot 112a. The wedge shape locking tab 110b may be formed axially above an undercut 240 in the post 210 that extends circumferentially inward from an edge 244 of the angular span 216 of the post 210. The wedge shape slot 112a may be formed by a circumferentially extending groove 250 that extends circumferentially outward from an edge 254 of the angular span 218 of the opening 212. For the slot 112a, the wedge shape may be formed by a relatively wider front portion 264 and a relatively narrower back portion 268 and extend circumferentially about the common rotation axis C-C about 8.0 degrees. For the locking tab 110b, the wedge shape may have a relatively narrower front portion at 278 that is the same in width as that of the relatively narrower back portion 268 of the slot 112b, and a relatively wider back portion at 274 that is the same in width as that of the relatively wider front portion 264 of the slot 112b. The wedge shape locking tab 110b likewise may extend about the common rotation axis C-C about 8.0 degrees. The wedge shape locking tab 110b may be configured to engage walls 280 of the wedge shape slot 112a as the second component 22 is rotated from the pre-assembled position of FIG. 5 into the assembled position shown in FIG. 6.

As shown in FIGS. 4-6, when assembling the second component 22 to the first component 20, the second component 22 is rotated counterclockwise relative to the first component 20. During assembly, the tabs 110b, 112b snugly fit into the respective slots 112a, 110a. The mating of the tabs 110b, 112b with the slots 112a, 110a prevents further counterclockwise movement of the second component 22 relative to the first component 20. In this regard, the tabs 110b, 112b and slots 112a, 110a provide a rotational locking feature. As will be described in greater detail below, the mating of the tabs 110b, 112b into the respective slots 112a, 110a, in combination with the mating of the spring actuated tabs 140a, 142a into the respective mounting holes 142b, 140b, rotationally locks the components 20, 22 together, that is, prevents relative counterclockwise or clockwise rotation between the first and second components.

The locking mechanism 200 may also be configured to axially lock the components 20, 22 together. The axial locking can be by way of merely seating the wedge shape locking tabs 110b, 112b into the respective wedge shape slots 112a, 110a such that the undersides of the tabs 110b, 112b slidingly abut the base walls of the respective wedge shape slots 112a, 110a. Alternatively, axial locking can be by way of an interference fit created between the wedge shape locking tabs 110b, 112b and the respective wedge shape slots 112a, 110a. Referring to FIG. 5, one way to create an axial interference fit between the wedge shape locking tab 110b and the wedge shape slot 112a, is to configure the axial height from the flange face 46b of the first component 20 to the underside of the wedge shape locking tab 110b to be less than the axial height from the flange face 48a of the second component 22 to the base wall of the wedge shape slot 112a. This interference fit axially clamps the second component 22 to the first component 20 and maintains the clamping force in the assembled position. As shown in FIG. 2, a locking mechanism 200 may be located on both sides of the channel 34. By seating or interference fitting the wedge shape locking tabs 110b, 112b to the respective wedge shape slots 112a, 110a, the components 20, 22 can be axially locked.

In the illustrative embodiment, the locking mechanisms 200 are located at the end 88 where the polarizer assembly 12 connects to the waveguides of the OMT waveguide device 84 of the satellite communications antenna system 10. As will be appreciated, the locking mechanisms 200 need not be limited to such location. For example, the locking mechanisms 200 may additionally or alternately be located at the end 90 where the polarizer assembly 12 connects to the feed horn 64. The locking mechanisms 200 may be located anywhere along the flanges 40a, 40b, 42a, 42b of the first and second components 20, 22.

Referring again to FIGS. 3 and 4, the plurality of first locking projections and/or first openings 100a, 100b may include a plurality of locking tabs 120a, 130a on the first flange 40a of the first component 20 that are progressively further radially spaced from the common rotation axis C-C. Similarly, the plurality of second locking projections and/or second openings 102a, 102b may include a plurality of slots 122b, 132b on the second flange 42b of the second component 22 that are progressively further radially spaced from the common rotation axis C-C. The locking tabs 120a, 130a may be configured to gradually engage the opposite mating slots 122b, 132b as the second component 22 is rotated from the pre-assembled position shown in FIG. 4 to the assembled position shown in FIG. 2. Once assembled, the engaged tabs 120a, 130a and mating slots 122b, 132b provide face to face retention between the flange faces 46b, 48a of the respective first and second components 20, 22.

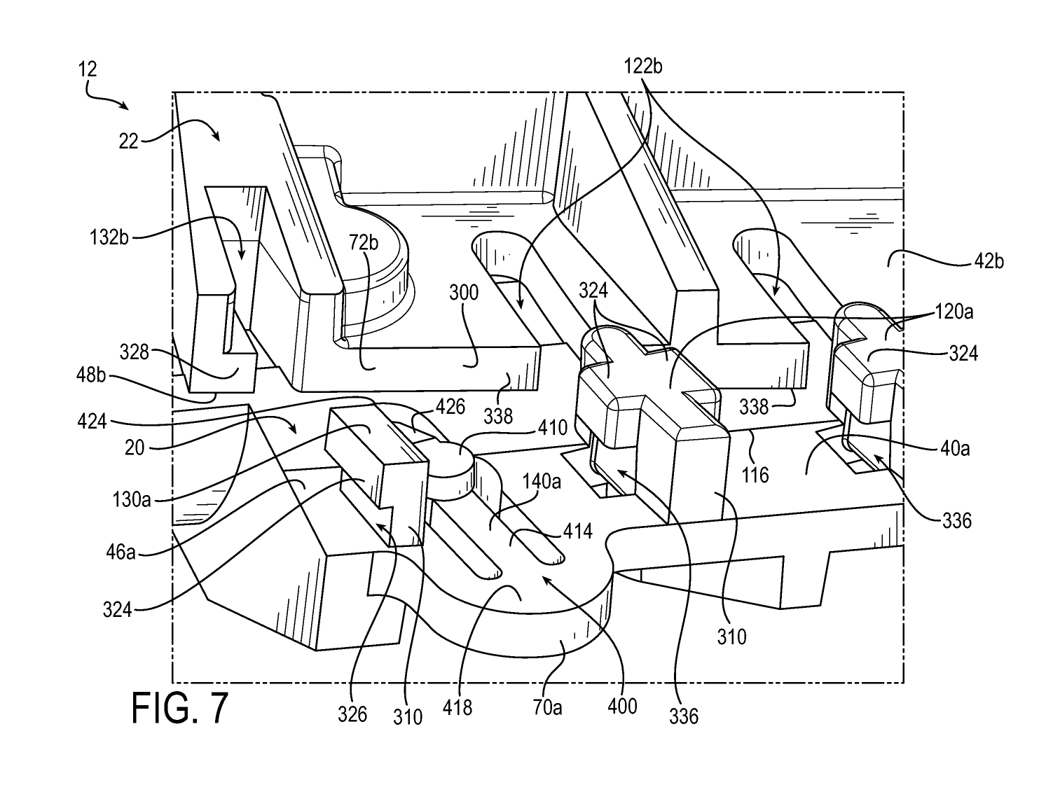

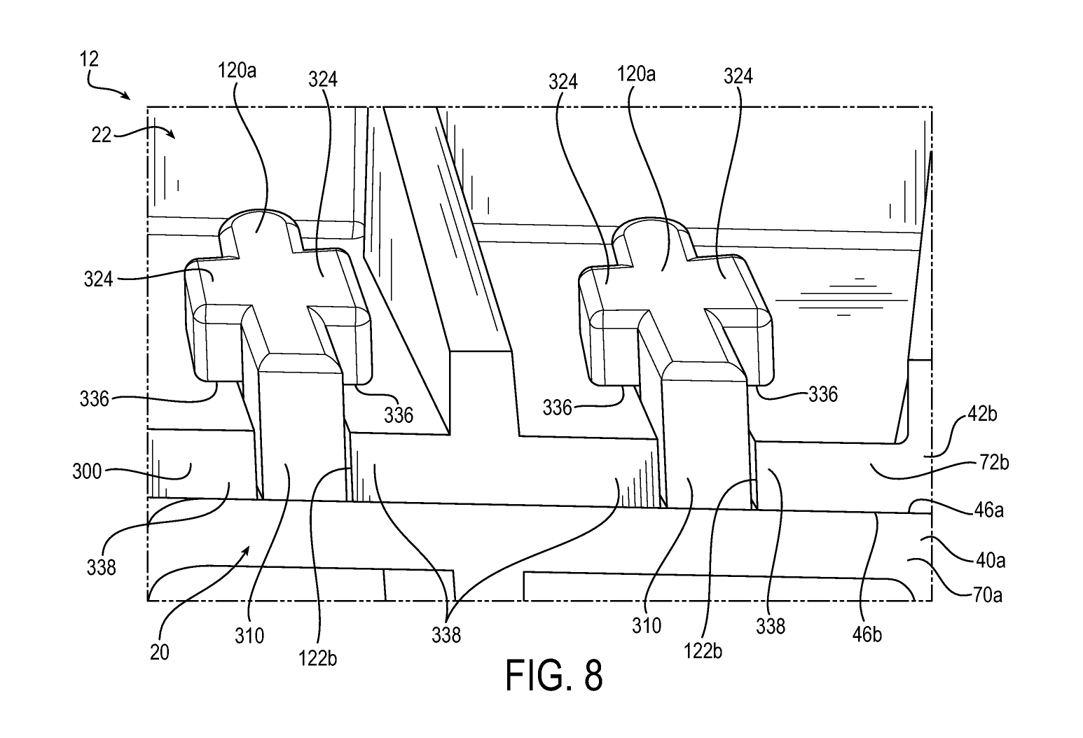

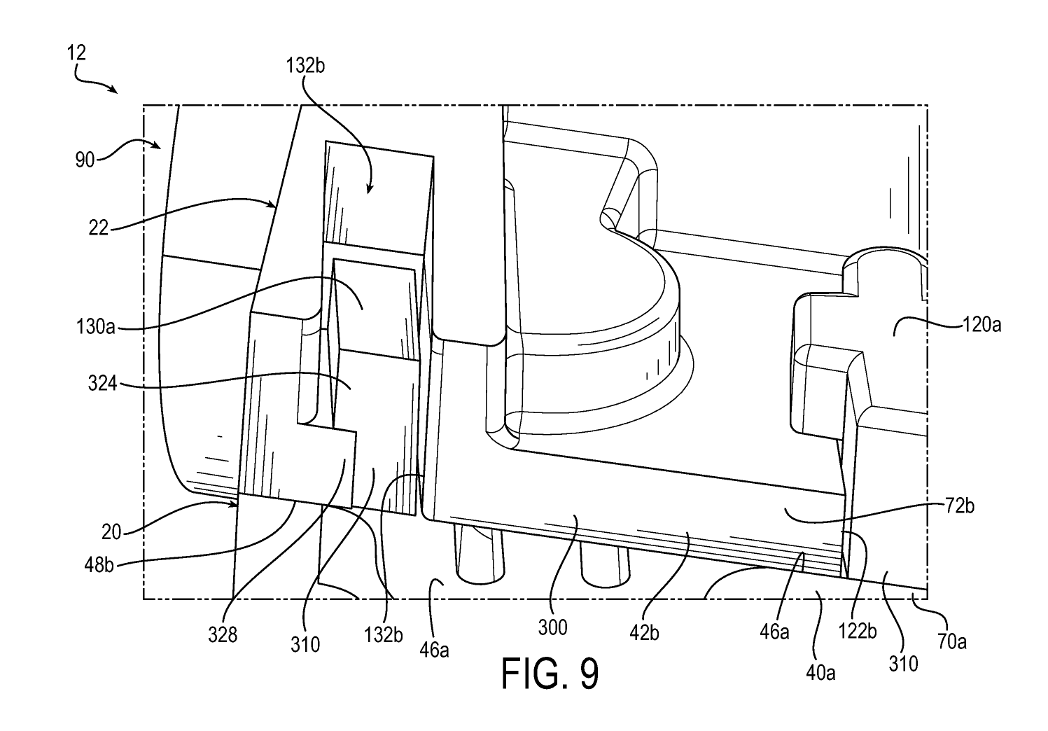

FIGS. 7-9 show greater detail of the locking tabs 120a, 130a and the mating slots 122b, 132b. The slots 122b, 132b open up to an edge 300 of the second flange 42b of the second component 22 and are configured to circumferentially slidably receive the respective locking tabs 120a, 130a of the first component 20 as the second component 22 is rotated from the pre-assembled position to the assembled position. The locking tabs 120a, 130a may include posts 310 projecting from the first flange face 46a of the first component 20 in the direction of the common rotation axis C-C, and at least one projection 324 extending laterally from the post 310, in the illustrative embodiment extending radially relative to the common rotation axis C-C. In the illustrative embodiment, the locking tab 130a that is furthest from the common rotation axis C-C, which is more clearly shown in FIGS. 7 and 9, includes one projection 324. As such, the locking tab 130a is also referred to herein as an L-shape locking tab 130a. The projection 324 and first flange face 46a may define therebetween a circumferentially extending guideway 326 within which an edge 328 of the corresponding mating slot 132b can move as the second component 22 is rotated to the assembled position. In the illustrative embodiment, the locking tabs 120a, which are more clearly shown in FIGS. 7 and 8, include a pair of laterally extending projections 324 that project radially toward and radially away from the post 310. As such, the locking tabs 120a are also referred to herein as T-shape locking tabs 120a. The projections 324 and first flange face 46a may define therebetween circumferentially extending guideways 336 within which opposite edges 338 of the corresponding mating slots 122b can move as the second component 22 is rotated to the assembled position.

The locking tabs 120a, 130a, 122a, 132a and respective mating slots 122b, 132b, 120b, 130b may be configured to axially lock the components 20, 22 together. The axial locking can be by way of merely sliding the locking tabs 120a, 130a, 122a, 132a into the respective mating slots 122b, 132b, 120b, 130b such that the upper and lower walls of the guideways 326, 336 of the locking tabs 120a, 130a, 122a, 132a, which correspond respectively to the undersides of the projections 324 and the portions of the flange faces 46a, 48a opposite thereto, slidingly abut the respective upper and lower walls of the edges 328, 338 of the slots 122b, 132b, 120b, 130b, which correspond to the upper and lower surface portions of the flanges 40b, 42b adjacent the slots 122b, 132b, 120b, 130b. Alternatively, axial locking can be by way of an interference fit created between the locking tabs 120a, 130a, 122a, 132a and the respective mating slots 122b, 132b, 120b, 130b. Referring to FIG. 7, one way to create an axial interference fit between the locking tabs 120a, 130a, 122a, 132a and the slots 122b, 132b, 120b, 130b, is to configure the axial height of the guideways 326, 336 to be less than the axial height of the edges 328, 338 of the slots 122b, 132b, 120b, 130b. This interference fit axially clamps the second component 22 to the first component 20 and maintains the clamping force in the assembled position. As shown in FIGS. 2 and 3, the locking tabs 120a, 130a, 122a, 132a and respective mating slots 122b, 132b, 120b, 130b may be located on both sides of the channel 34. By sliding or interference fitting the locking tabs 120a, 130a, 122a, 132a to the respective slots 122b, 132b, 120b, 130b, the components 20, 22 can be axially locked.

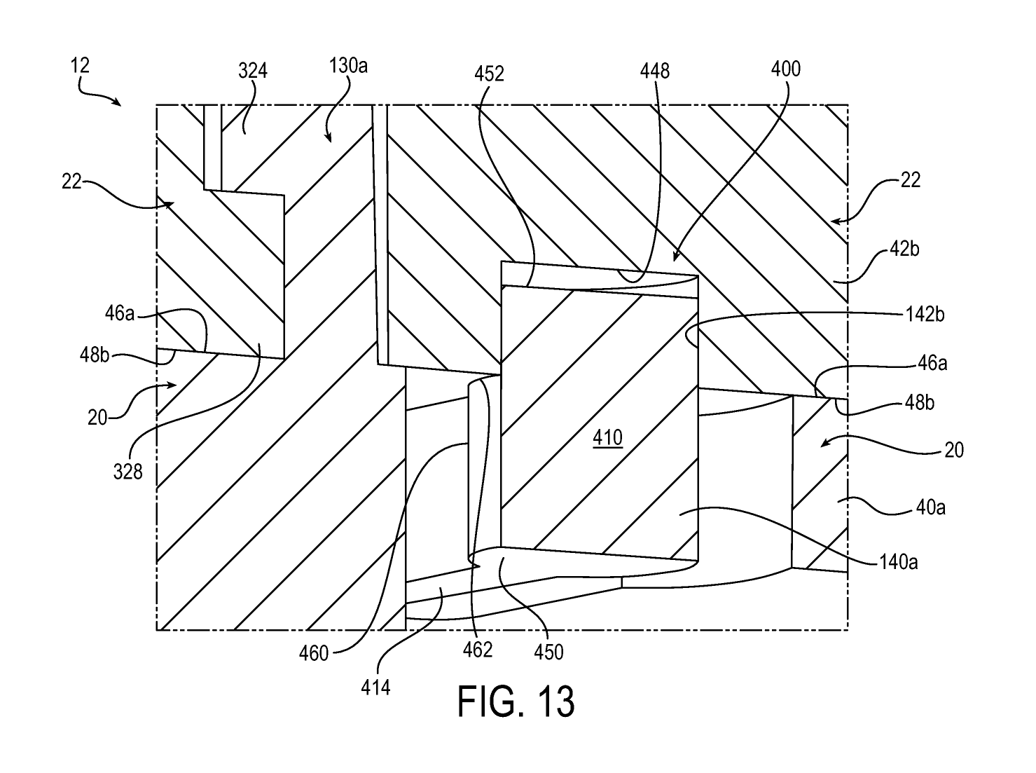

FIGS. 2, 4, 7 and 10-13 show details of a snap locking mechanism 400 that rotationally locks the second component 22 to the first component 20 of the polarizer assembly 12. The snap locking mechanism 400 may include the spring actuated tab 140a of the first component 20 and the mounting hole 142b of the second component 22. FIGS. 4 and 7 show the snap locking mechanism 400 in a pre-assembled position in which the spring actuated tab 140a and mounting hole 142b are not engaged, while FIGS. 2 and 13 show the snap locking mechanism 400 (two snap locking mechanisms 400 in FIG. 2) in an assembled position in which the spring actuated tab 140a is received in and engaged with the mounting hole 142b to rotationally lock the second component 22 to the first component 20. In one form, the snap locking mechanism 400 is configured to lock the second component 22 to the first component 20 when proper alignment of the first and second components 20, 22 is achieved.

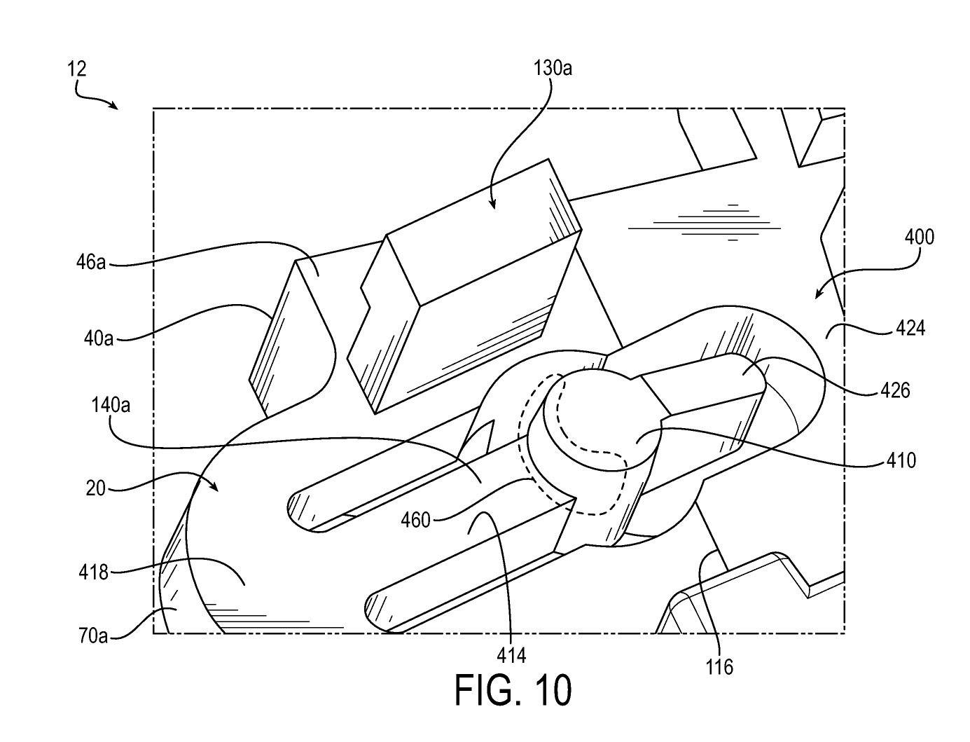

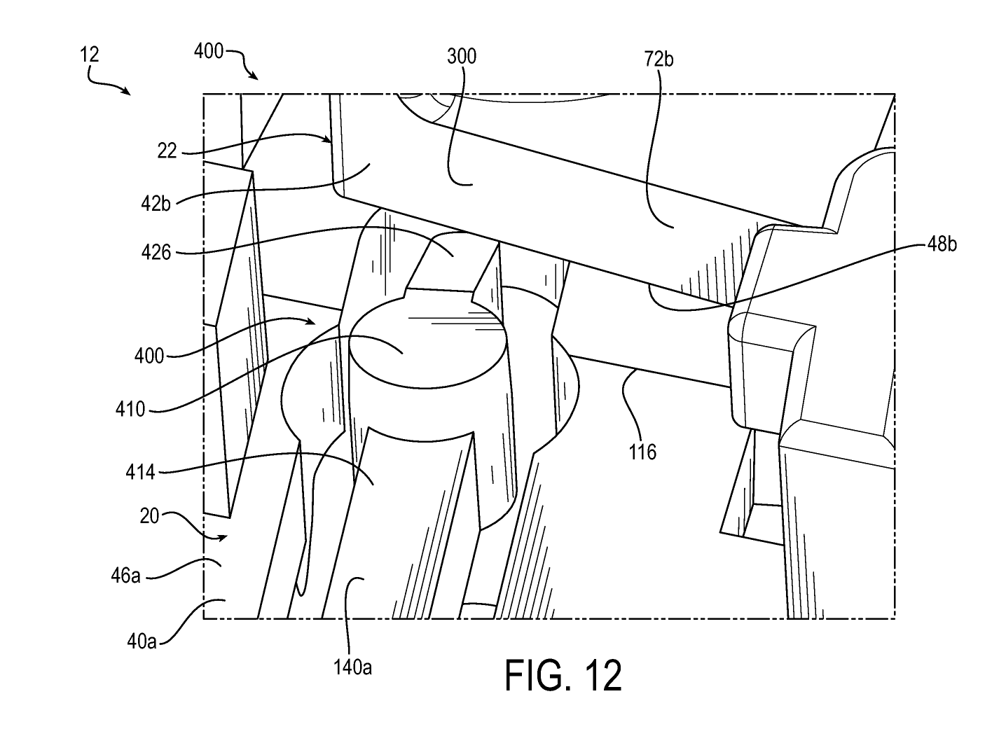

The spring actuated tab 140a may be configured to flex away from the second component 22 as the second component 22 is rotated from the pre-assembled position of FIG. 4 toward the assembled position of FIG. 2, and to flex back toward the second component 22 in the assembled position. As shown in FIGS. 10 and 12, the spring actuated tab 140a may include a tab 410 connected to a flexible cantilever arm 414. The flexible cantilever arm 414, in turn, may be connected to an outer portion 418 of the first flange 40a of the first component 20 and project circumferentially toward the first channel portion 30 (see FIG. 3). The flexible cantilever arm 414 may be configured to flex as the second component 22 is rotated from the pre-assembled position toward the assembled position.

FIG. 12 shows one way by which the flexure may be realized. In FIG. 12, the flexible cantilever arm 414 includes a ramp 426 that the second component 22 slides against to gradually flex the cantilever arm 414 as the second component 22 is rotated from the pre-assembled position toward the assembled position. The ramp 426 may extend circumferentially relative to the common rotation axis C-C in a direction opposite that of where the cantilever arm 414 connects to the outer portion 418 of the first flange 40a. As the second component 22 is rotated relative to the first component 20, the ramp 426 engages the edge 300 of the flange 42b of the second component 22, and then the edge 300 of the second component 22 drives the ramp 426 axially downward, that is, axially away from the second component 22. It will be appreciated that the flexible cantilever arm 414 can be connected to the first component 20 at a connection point other than the outer portion 418 of the first flange 40a. For example, the flexible cantilever arm 414 can be connected to an inner portion 424 of the first flange 40a of the first component 20 and project circumferentially toward the outer edge 70a of the first flange 40a, in which case the ramp 426 may form the cantilever arm 414 with the tab 410 being located at a distal free end of the ramp 426.

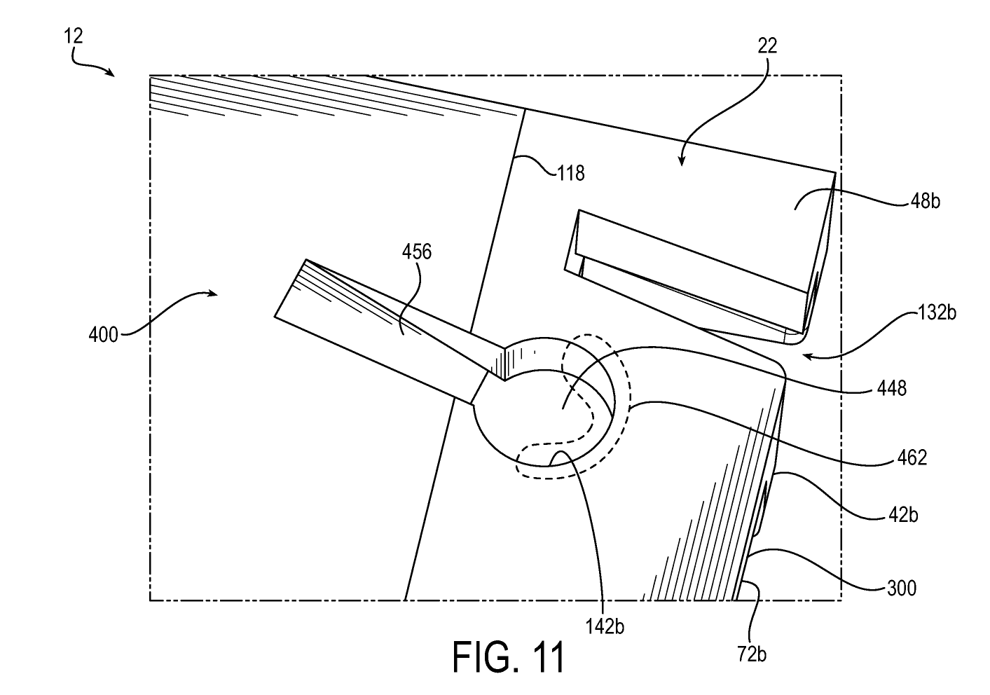

FIGS. 11 and 13 show the mounting hole 142b side of the snap locking mechanism 400. The mounting hole 142b may be formed as a hole, slot, cavity, recess, etc. in the second flange 42b of the second component 22. The depth of the mounting hole 142b below the flange face 48b of the second flange 42b enables the tab 410 of the spring actuated tab 140a to drop into the mounting hole 142b when the second component 22 reaches the rotational position achieved in the assembled position of FIG. 2. In the illustrative embodiment, the tab 410 and mounting hole 142b are round shape, and the circumference of the tab 410 is slightly less in size than the circumference of the mounting hole 142b to enable the tab 410 to slidably fit into the mounting hole 142b. As will be appreciated, the spring constant associated with the cantilever arm 414 of the spring actuated tab 140a can be selected to urge the tab 410 into the mounting hole 142b. For relatively greater clearance between the tab 410 and mounting hole 142b the spring constant can be designed to be relatively less, while for relatively less clearance between the tab 410 and mounting hole 142b the spring constant can be designed to be relatively greater. FIG. 13 shows the tab 410 of the spring actuated tab 140a fully engaged into the mounting hole 142b. As shown in FIG. 13, when the spring actuated tab 140a fits into the mounting hole 142b, the tab 410 thereof need not reach the bottom 448 of the mounting hole 142b. Of course, the tab 410 and mounting hole 142b can also be configured such that the periphery of the tab 410 engages the inner periphery of the mounting hole 142b before (or when) the tab 410 reaches its unflexed position. Further, to facilitate centering of the tab 410 into the mounting hole 142b, and thus further aiding in rotationally and axially aligning the first and second components 20, 22 together in the assembled position, the tab 410 and/or mounting hole 142b may be tapered. Referring to FIG. 13, the mounting hole 142b can taper, for example, as it extends axially from the flange face 48b to its bottom 448, and the tab 410 can taper, for example, as it extends axially from its bottom 450 to its top 452.

The snap locking mechanism 400 may also provide a clearance slot 456 that corresponds in position to the ramp 426 of the spring actuated tab 140a when the first and second components 20, 22 are in the assembled position. Thus, referring to FIG. 11, the clearance slot 456 may extend circumferentially relative to the common rotation axis C-C in a direction opposite that of the edge 300 of the second flange 42b of the second component 22. The depth of the clearance slot 456 below the flange face 48b of the second flange 42b enables the ramp 426 of the spring actuated tab 140a to drop into the clearance slot 456 when the second component 22 reaches the full rotational position achieved in the assembled position of FIG. 2. The clearance slot 456 receives the ramp 426 so that the cantilever arm 414 is not held in the flexed position when the tab 410 drops into the mounting hole 142b.

Once the second component 22 is assembled to the first component 20, and the tab 410 and ramp 426 have dropped or been urged into the respective mounting hole 142b and clearance slot 456, the side 460 (FIGS. 10 and 13) of the tab 410 facing a direction opposite that of the rotational direction for assembling the components 20, 22, which in the illustrative embodiment is also the side 460 of the tab 410 opposite that of the ramp 426, abuts an opposing surface 462 (FIGS. 11 and 13) of the mounting hole 142b. As shown in FIGS. 4 and 10-13, when assembling the second component 22 to the first component 20, the second component 22 is rotated counterclockwise relative to the first component 20. In the assembled position, with the tabs 410 of the spring actuated tabs 140a, 142a snugly fit into the respective mounting holes 142b, 140b, the side 460 of the tab 410 abuts the side 462 of the mounting hole 142b, 140b to prevent the second component 22 from reverse rotating relative to the first component 20, that is, to prevent the second component 22 from rotating clockwise relative to the first component 20. In this regard, the spring actuated tabs 140a, 142a and mounting holes 142b, 140b provide a rotational locking feature. The mating of the spring actuated tabs 140a, 142a into the respective mounting holes 142b, 140b, in combination with the mating of the tabs 110b, 112b into the respective slots 112a, 110a, rotationally locks the components 20, 22 together, that is, prevents relative counterclockwise or clockwise rotation between the first and second components 20, 22.

In the illustrative embodiment, the snap locking mechanisms 400 are located at the end 90 where the polarizer assembly 12 connects to the feed horn 64 of the satellite communications antenna system 10. As will be appreciated, the snap locking mechanisms 400 need not be limited to such location. For example, the snap locking mechanisms 400 may additionally or alternately be located at the end 88 where the polarizer assembly 12 connects to the waveguides of the OMT waveguide device 84. The snap locking mechanisms 400 may be located anywhere along the flanges 40a, 40b, 42a, 42b of the first and second components 20, 22.

In addition, the spring actuated tabs 140a of the snap locking mechanisms 400 are described as having flexible cantilever arms 414 to realize their spring biased actuation. It will be appreciated that any spring means may be used to realize the spring biased actuation. For example, the cantilever arm 414 can be omitted and the tab 410 can instead form a distal end of a spring plunger installed into a push-fit hole in the first component 20. In this configuration, the spring loaded tab 410 depresses against the load of the spring plunger as the edge 300 of the second component 22 urges the ramp 426 downward as the second component 22 is rotated relative to the first component 20 from the pre-assembled position toward the assembled position. Once the second component 22 reaches the assembled position, the spring loaded tab 410 of the first component 20 then snaps into the mounting hole 142b in the second component 22 to rotationally lock the components 20, 22. In another form, the spring actuated tab 140a may take the form of a nub or protrusion on a flange of the first component 20 and a corresponding cavity or recess in the second component 22. In this configuration, the flanges of the first and second components 20, 22 may be configured to deflect away from each other due to the nub urging the flanges apart as the second component 22 is rotated relative to the first component 20 from the pre-assembled position toward the assembled position. Once the second component 22 reaches the assembled position, the nub then snaps into the corresponding cavity of the second component 22, causing the flanges to flex toward each other, and the engagement of the nub and cavity rotationally locking the components 20, 22.

In the above, the tabs 410 and mounting holes 142b are shown and described as having a round shape. It will be appreciated that shapes other than round are also contemplated, so long as the tab 410 and mounting hole 142b provide respective abutting surfaces 460 and 462 (round or otherwise) that contact one another to prevent reverse rotation of the second component 22 relative to the first component 20 once the second component 22 has reached the assembled position shown in FIG. 2. For example, the tab 410 and mounting hole 142b may have a square shape, or a flat top pyramid shape, among others.

The polarizer assembly 12 is described as including a pair of snap locking mechanisms 400 at the feed horn connection end 90 and a pair of locking mechanisms 200 at the waveguide connection end 88. Referring to FIG. 4, the locking mechanisms 200 prevent further counterclockwise rotation of the second component 22 relative to the first component 20 once the second component 22 has reached the assembled position shown in FIG. 2, where for example the wedge shape locking tabs 110b, 112b seat in, or interference fit with, the respective wedge shape slots 112a, 110a as shown in FIGS. 5 and 6. The snap locking mechanisms 400 prevent reverse rotation (clockwise rotation in FIG. 4) of the second component 22 relative to the first component 20 once the second component 22 has reached the assembled position shown in FIG. 2, where for example the tabs 410 seat in the respective mounting holes 142b as shown in FIG. 13. The polarizer assembly 12 need not be limited to such configuration and other embodiments are contemplated. In one form, for example, a single locking mechanism 200 may be provided at the waveguide connection end 88 and a single snap locking mechanism 400 at the feed horn connection end 90. The single locking mechanism 200 and single snap locking mechanism 400 can be on opposite sides of the channel 34, or both on one side of the channel 34. In another form, the locking mechanism 200 may be located at the same end, whether the waveguide connection end 88 or the feed horn connection end 90, as the snap locking mechanism 400.

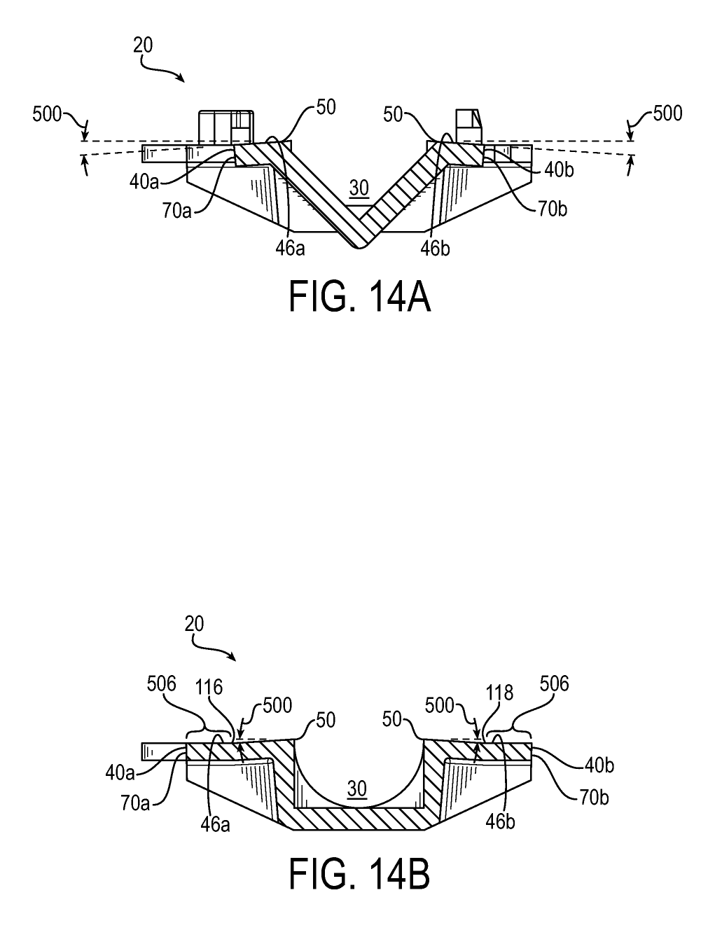

Referring now to FIGS. 14A and 14B, there are shown cross sections of the first component 20, shown in FIG. 3, at the waveguide connection end 88 and central portion thereof, respectively. The first flanges 40a, 40b of the first component 20 may be configured to create an interference fit between the edges 50 of the first channel portion 30 and the corresponding edges 52 of the opposing second channel portion 32 when the first and second components 20, 22 are assembled together as shown in FIG. 2, and in cross section in FIGS. 2A-2C. In FIG. 14A, the interference fit is obtained by the first flanges 40a, 40b being sloped at 500 about 0.5 to 3.5 degrees relative to horizontal from the edges 50 of the first channel portion 30 to the outer edges 70a, 70b of the first flanges 40a, 40b. FIG. 2A shows the first flanges 40a, 40b in the horizontal position at the waveguide connection end 88 of the polarizer assembly 12. As shown in FIG. 14B, the interference fit can be obtained by the first flanges 40a, 40b being sloped at 500 about 0.5 to 3.5 degrees relative to horizontal from the edges 50 of the first channel portion 30 to a clamping centerline 116, 118 of the respective first flanges 40a, 40b, and then horizontal at a portion 506 from the clamping centerline 116, 118 outward to the outer edges 70a, 70b of the first flanges 40a, 40b. FIG. 2B shows the first flanges 40a, 40b in the horizontal position at the central portion of the polarizer assembly 12. The second component 22 has the same configuration owing to the one part geometry of the first and second components 20, 22 of the polarizer assembly 12.

As the second component 22 is rotated relative to the first component 20 from the pre-assembled position of FIG. 4 to the assembled position of FIG. 2, the edges 52 of the second channel portion 32 are gradually clamped into an interference fit with the edges 50 of the first channel portion 30. During the rotation of the second component 22 relative to the first component 20, the first locking projections and/or first openings 100a, 100b on opposite sides of the first channel portion 30 gradually engage and mate with the respective second locking projections and/or second openings 102b, 102a on opposite sides of the second channel portion 32, to thereby gradually compress the edges 52 of the second channel portion 32 into interference fit with the edges 50 of the first channel portion 30 to form a tight seal bead along the edges 50, 52 of the respective first and second channel portions 30, 32. In effect, the first locking projections and/or first openings 100a, 100b and the second locking projections and/or second openings 102b, 102a gradually urge the second component 22 closer and closer together with the first component 20 in a corkscrew like manner.

An interference fit at the edges 50, 52 of the first and second channel portions 30, 32 can also be implemented at the feed horn connection end 90 of the polarizer assembly 12. The configuration and description of the flanges of the first and second components 20, 22 would be as shown and described for the central portion of the polarizer assembly 12, which was described above with respect to FIG. 14B. As such, a cross section of the first component 20 at the feed horn end 90 and description thereof is omitted.

The interference fit at the edges 50, 52 of the channel portions 30, 32 can be created in any number of ways and need not be limited to that which is described with respect to FIGS. 14A and 14B, as will be appreciated. In one form, for example, for the first component 20, the first flanges 40a, 40b may be curved rather than ramped from the edges 50 of the first channel portion 30 to the outer edges 70a, 70b of the first flanges 40a, 40b in FIGS. 14A and 14B, with the clamping centerlines 116, 118 forming the bottom of the curve in FIG. 14B. In another form, the first flanges 40a, 40b may have a slightly greater thickness at the edges 50 of the first channel portion 30 than at the outer edges 70a, 70b of the first flanges 40a, 40b to create an interference fit with the corresponding edges 52 of the opposing second component 22. The first flanges 40a, 40b for example can be tapered from the edges 50 of the first channel portion 30 to the outer edges 70a, 70b of the first flanges 40a, 40b.

It will be appreciated that, in certain applications, an interference fit such as described with respect to FIGS. 14A and 14B may not be necessary or desired. In such case, the ramps at 500 and 506 may be omitted. It will also be appreciated that, as described above, the mating together of the first and second components 20, 22 by the first locking projections and/or first openings 100a, 100b with the opposite respective second locking projections and/or second openings 102b, 102a can be by way of an interference fit that yields an engaging and compressing together of the first and second components 20, 22 to form a tight seal bead at the edges 50, 52 of the respective channel portions 30, 32, even without the interference fit configurations described with respect to FIGS. 14A and 14B.

It will further be appreciated that, in certain applications, an interference fit such as described with respect to FIGS. 14A and 14B may be the main source of interference fitting the edges 50, 52 of the respective channel portions 30, 32. Thus, for example, the mating together of the first and second components 20, 22 by the first locking projections and/or first openings 100a, 100b with the opposite respective second locking projections and/or second openings 102b, 102a can be by way of a sliding and/or seating fit, and in this sliding and/or seating fit the first locking projections and/or first openings 100a, 100b gradually engage and mate with the respective second locking projections and/or second openings 102b, 102a, to thereby gradually compress the edges 52 of the second channel portion 32 into interference fit with the edges 50 of the first channel portion 30 to form a tight seal bead along the edges 50, 52 of the respective first and second channel portions 30, 32. The compressing together of the edges 50, 52 can be by way of the axial locking functions described above with respect to the locking mechanisms 200, the snap locking mechanisms 400, and the engaging of the locking tabs 120a, 130a, 122a, 132a with the respective mating slots 122b, 132b, 120b, 130b, whether or not the axial locking functions themselves are configured for interference fits.

As shown in FIGS. 2-3, the common rotation axis C-C, or pivot location, of the first and second components 20, 22 is located at the waveguide connection end 88 of the polarizer assembly 12, approximately midway along the “diamond” shape portion of the channel 34. It will be appreciated that the common rotation axis C-C could be located elsewhere along the length of the first and second components 20, 22. For example, the common rotation axis C-C may be located at the feed horn connection end 90 of the polarizer assembly 12, or in the central portion between the waveguide connection end 88 and the feed horn connection end 90 of the polarizer assembly 12. It will be appreciated that a 0.5 (half) degree of angular misalignment about the axis C-C translates into a greater arc distance misalignment at the far end than at the pivot end C-C. The inventor has found that in certain applications the feed horn connection end 90 of the polarizer assembly 12 is more forgiving than the waveguide connection end 88 in terms of how angular misalignment affects performance of the polarizer assembly 12. It therefore is preferable that the effects of angular misalignment be minimized at the waveguide connection end 88. By placing the common rotation axis C-C at the waveguide connection end 88, angular misalignment translates into significantly less arc distance misalignment at the waveguide connection end 88 than if the common rotation axis C-C was located at the feed horn connection end 90. Of course, in other applications it may be preferable to locate the common rotation axis C-C closer to the feed horn connection end 90 than the waveguide connection end 88.

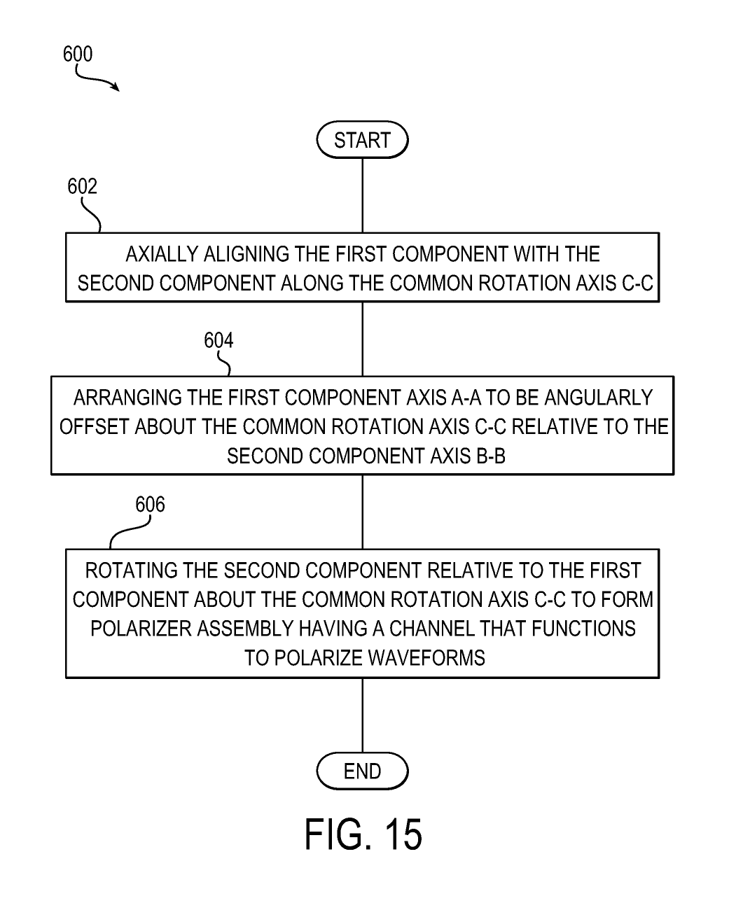

FIG. 15 shows a flowchart 600 of an exemplary method of assembling a polarizer assembly 12. In the first step 602, the first component 20 is axially aligned with the second component 22 along the common rotation axis C-C, as shown in FIG. 4. The first component 20 includes the first channel portion 30 extending along the first component axis A-A and having the plurality of first locking projections and/or first openings 100a, 100b on opposite sides of the first channel portion 30. The second component 22 includes the second channel portion 32 extending along the second component axis B-B and having the plurality of second locking projections and/or second openings 102a, 102b on opposite sides of the second channel portion 32. In the second step 604, the first component axis A-A of the first component 20 is arranged to be angularly offset about the common rotation axis C-C relative to the second component axis B-B of the second component 22, as shown in FIG. 4. In the third step 606, the second component 22 is rotated relative to the first component 20 about the common rotation axis C-C from the pre-assembled position shown in FIG. 4 to the assembled position shown in FIG. 2, whereby the first locking projections and/or first openings 100a, 100b mate with the second locking projections and/or second openings 102a, 102b and the first and second channel portions 30, 32 form the channel 34 that functions to polarize waveforms.

Referring to the embodiment illustrated in FIGS. 4 and 5, the step 602 of axially aligning the first and second components 20, 22 along the common rotation axis C-C can include sliding the post 210 of the first component 20 axially into the opening 212 in the second component 22 in the direction of the common rotation axis C-C.

As was also described above with respect to the mating of the plurality of first locking projections and/or first openings 100a, 100b and the plurality of second locking projections and/or second openings 102a, 102b, as well as with respect to the sloping of the flanges in the embodiment of FIGS. 14A and 14B, as the second component 22 is rotated relative to the first component 20 from the pre-assembled position to the assembled position, the edges 52 of the second channel portion 32 can be gradually clamped into an interference fit with the edges 50 of the first channel portion 30.

As was described with respect to the embodiment of FIG. 7 and FIGS. 10-13, the method may also include flexing the spring actuated tab 140a away from the second component 22 as the second component 22 is rotated from the pre-assembled position toward the assembled position, and flexing the spring actuated tab 140a back toward the second component 22 in the assembled position to rotationally lock the second component 22 to the first component 20.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A polarizer assembly, comprising:
a first component including a first channel portion extending along a first component axis and having a plurality of first locking projections and/or first openings on opposite sides of the first channel portion; and
a second component including a second channel portion extending along a second component axis and having a plurality of second locking projections and/or second openings on opposite sides of the second channel portion;
wherein the second component is rotatable relative to the first component about a common rotation axis between a pre-assembled position in which the second component axis is angularly offset from the first component axis, and an assembled position in which the second locking projections and/or second openings mate with the first locking projections and/or first openings and the first and second channel portions form a channel that functions to polarize waveforms.

2. The polarizer assembly of claim 1, wherein the first and second components have the same geometry.

3. The polarizer assembly of claim 1, wherein in the assembled position the first and second components are configured to attach to a waveguide at one end and a feed horn at an opposite end, and the common rotation axis is positioned closer to the waveguide end.

4. The polarizer assembly of claim 1, wherein the channel is square at one end and circular at an opposite end.

5. The polarizer assembly of claim 1, wherein the plurality of first locking projections and/or first openings are formed in first flanges on opposite sides of the first channel portion, and the plurality of second locking projections and/or second openings are formed in second flanges on opposite sides of the second channel portion.

6. The polarizer assembly of claim 1, wherein in the assembled position the plurality of second locking projections and/or second openings mate with the plurality of first locking projections and/or first openings to clamp respective edges of the first and second channel portions into an interference fit.

7. The polarizer assembly of claim 1, wherein the plurality of first locking projections and/or first openings includes a plurality of first tabs and/or slots, and the plurality of second locking projections and/or second openings includes a plurality of second tabs and/or slots.

8. The polarizer assembly of claim 1, wherein the plurality of first locking projections and/or first openings are progressively further radially spaced from the common rotation axis, and the plurality of second locking projections and/or second openings are progressively further radially spaced from the common rotation axis.

9. The polarizer assembly of claim 1, wherein the first component includes a post that is configured to slide axially into an opening in the second component in the direction of the common rotation axis to align the first and second components along the common rotation axis.

10. The polarizer assembly of claim 9, wherein the post has an arc shape and the opening has an arc shape, and the angular span of the arc shape post is less than the angular span of the arc shape opening.

11. The polarizer assembly of claim 9, wherein the arc shape post is configured to slidably fit into the arc shape opening to angularly offset the second component axis relative to the first component axis and position the first and second components into the pre-assembled position.

12. The polarizer assembly of claim 9, wherein an inner radius of the post slides against an outer radius of a wall of the opening to guide rotational movement of the second component relative to the first component between the pre-assembled position and the assembled position.

13. The polarizer assembly of claim 9, wherein the plurality of first locking projections and/or first openings includes a wedge shape locking tab, and the plurality of second locking projections and/or second openings includes a wedge shape slot, wherein the wedge shape locking tab is configured to engage walls of the wedge shape slot as the second component is rotated into the assembled position.

14. The polarizer assembly of claim 13, wherein the wedge shape locking tab is formed axially above an undercut in the post that extends circumferentially inward from an edge of an angular span of the post, and the wedge shape slot is formed by a groove that extends circumferentially outward from an edge of an angular span of the opening.

15. The polarizer assembly of claim 1, wherein the plurality of first locking projections and/or first openings includes locking tabs progressively further radially spaced from the common rotation axis, and the plurality of second locking projections and/or second openings includes slots progressively further radially spaced from the common rotation axis.

16. The polarizer assembly of claim 15, wherein the progressively further radially spaced slots open up to an edge of a second flange of the second component and are configured to circumferentially slidably receive the respective progressively further radially spaced locking tabs of the first component as the second component is rotated from the pre-assembled position to the assembled position.

17. The polarizer assembly of claim 15, wherein the locking tabs include posts projecting from a first flange face of the first component axially in the direction of the common rotation axis, and at least one projection extending laterally from the post, the projection and first flange face defining therebetween a circumferentially extending guideway within which an edge of the corresponding mating slot moves as the second component is rotated to the assembled position.

18. The polarizer assembly of claim 17, wherein the at least one laterally extending projection includes a pair of laterally extending projections that project radially toward and radially away from the post, the projections and first flange face defining therebetween circumferentially extending guideways within which opposite edges of the corresponding mating slot move as the second component is rotated to the assembled position.

19. The polarizer assembly of claim 17, wherein the at least one laterally extending projection of the locking tab furthest from the common rotation axis projects radially from the post.

20. The polarizer assembly of claim 1, wherein the first component includes a spring actuated tab and the second component includes a mounting hole that receives the spring actuated tab in the assembled position to rotationally lock the second component to the first component.

21. The polarizer assembly of claim 20, wherein the spring actuated tab is configured to flex away from the second component as the second component is rotated from the pre-assembled position toward the assembled position, and to flex back toward the second component in the assembled position.

22. The polarizer assembly of claim 20, wherein the spring actuated tab includes a tab connected to a flexible cantilever arm that in turn is connected to a portion of a flange of the first component, the flexible cantilever arm being configured to flex as the second component is rotated from the pre-assembled position toward the assembled position.

23. The polarizer assembly of claim 22, wherein the flexible cantilever arm includes a ramp that the second component slides against to gradually flex the cantilever arm as the second component is rotated from the pre-assembled position toward the assembled position.

24. The polarizer assembly of claim 22, wherein the flexible cantilever arm is connected to an outer portion of the first flange and projects circumferentially toward the first channel portion.

25. A method of assembling a polarizer assembly, comprising:
aligning a first component and a second component axially along a common rotation axis,
the first component including a first channel portion extending along a first component axis and having a plurality of first locking projections and/or first openings on opposite sides of the first channel portion,
the second component including a second channel portion extending along a second component axis and having a plurality of second locking projections and/or second openings on opposite sides of the second channel portion;
arranging the first component axis of the first component to be angularly offset about the common rotation axis relative to the second component axis of the second component; and
rotating the second component relative to the first component about the common rotation axis from the pre-assembled position to an assembled position in which the first locking projections and/or first openings mate with the second locking projections and/or second openings and the first and second channel portions form a channel that functions to polarize waveforms.

26. The method of claim 25, wherein axially aligning the first and second components along the common rotation axis includes sliding a post of the first component axially into an opening in the second component in the direction of the common rotation axis.

27. The method of claim 25, wherein as the second component is rotated relative to the first component from the pre-assembled position to the assembled position, edges of the second channel portion are gradually clamped into an interference fit with edges of the first channel portion.

28. The method of claim 25, further comprising flexing a spring actuated tab away from the second component as the second component is rotated from the pre-assembled position toward the assembled position, and flexing the spring actuated tab back toward the second component in the assembled position to rotationally lock the second component to the first component.
